(19) United States
(12) Patent Application Publication
(10) Pub. No.: US 2013/0163807 A1
(43) Pub. Date: Jun. 27, 2013

(54) ELECTRO-ACOUSTIC TRANSDUCER AND METHOD OF MANUFACTURING THE SAME

(71) Applicant: CHUNG HUA UNIVERSITY, HSINCHU (TW)

(72) Inventor: Jium Ming LIN, HSINCHU (TW)

(73) Assignee: CHUNG HUA UNIVERSITY, HSINCHU (TW)

(21) Appl. No.: 13/726,430

(22) Filed: Dec. 24, 2012

(30) Foreign Application Priority Data
Dec. 27, 2011 (TW) 100148803

(51) Int. Cl. H04R 3/00; H04R 31/00

(52) U.S. Cl. CPC H04R 3/00; H04R 31/00
USPC 381/396; 29/594

(57) ABSTRACT

An electro-acoustic transducer includes an insulative flexible substrate, a base, and a magnetic field generator. The base includes a cavity and a magnetic portion disposed below the cavity. The insulative flexible substrate is configured to cover the cavity. The magnetic field generator can be disposed on the insulative flexible substrate and corresponds to the cavity. The magnetic field generator can produce a magnetic field and a reverse magnetic field to cause the magnetic field generator and the magnetic portion of the base to attract and repel each other, thereby vibrating the insulative flexible substrate.

### CROSS-REFERENCE TO RELATED APPLICATION

The present application is based on, and claims priority from, Taiwan Patent Application Serial Number 100148803, filed on Dec. 27, 2011, the disclosure of which is hereby incorporated by reference herein in its entirety.

### BACKGROUND OF THE INVENTION

1. Field of the Invention

The present invention relates to an electro-acoustic transducer.

2. Description of the Related Art

An ultra-thin, flexible speaker (also called a paper-thin, flexible speaker or an electrostatic speaker) has a first electrode, a second electrode, and a vibratile, thin metal film substrate, which carries positive charges and is disposed between the first electrode and the second electrode. When positive charges are transferred to the first electrode and negative charges are transferred to the second electrode, the metal film substrate moves away from the first electrode but closer to the second electrode; however, when negative charges are transferred to the first electrode and positive charges are transferred to the second electrode, the metal film substrate moves closer to the first electrode but away from the second electrode. When the changes of the electric polarities of the first and second electrodes continue, the metal film substrate will vibrate, compress air, and produce sound waves.

The vibratile, thin metal film substrate can be obtained by vapor-depositing an electrically conductive metal layer on a Mylar substrate. Charges are transferred to the thin metal film in order to carry charges.

It is insufficient to only use small audio electric signals to generate useful forces of electrostatic attraction and repulsion to drive a thin flexible speaker. Normally, a voltage booster is needed to amplify the audio frequency signals, which then increasing their voltage levels. Unfortunately, the danger of electric shock may be caused by such high voltages.

### SUMMARY OF THE INVENTION

One embodiment of the present invention provides an electro-acoustic transducer, which comprises an insulative flexible substrate, a base, and a magnetic field generator. The base comprises a cavity and a magnetic portion. The magnetic portion can be below the cavity. The insulative flexible substrate can cover the cavity. The magnetic field generator is disposed on the insulative flexible substrate and corresponds to the cavity. The magnetic field generator is configured to generate a magnetic field and a reverse magnetic field to cause the magnetic field generator and the magnetic portion of the base to attract and repel each other, thereby vibrating the insulative flexible substrate.

In one embodiment, to achieve a desired resonant effect to sounds in a frequency range, a plurality of openings can be formed in the insulative flexible substrate to allow air to flow into or out of the cavity. The size and the depth of the cavity can be changed to generate a desired resonant effect to sounds in a desired frequency range.

Another embodiment of the present invention provides an electro-acoustic transducer, which comprises an insulative flexible substrate, a base, a coil, a signal processor, and an audio signal connector. The insulative flexible substrate can comprise a first surface and a second surface. The base can comprise a cavity and a magnetic portion. The base can be attached to the first surface of the insulative flexible substrate. The insulative flexible substrate can cover the cavity. The magnetic portion and the first surface can be disposed on opposite sides of the cavity. The coil can be disposed on the second surface, corresponding to the cavity. The coil can generate a magnetic field and a reverse magnetic field to cause the coil and the magnetic portion of the base to attract and repel each other, thereby vibrating the insulative flexible substrate. The signal processor is coupled with the coil. The signal processor is configured to filter and amplify an audio signal and to drive the coil to generate the magnetic field and the reverse magnetic field. The audio signal connector is coupled with the signal processor. The audio signal connector is configured to provide the coil with a signal that causes the coil to generate the magnetic field or the reverse magnetic field.

In one embodiment, to achieve a desired resonant effect to make sounds in a frequency range, the size, shape, and thickness of the coil can be changed.

One embodiment of the present invention discloses a method of manufacturing an electro-acoustic transducer. The method comprises forming a coil on an insulative flexible substrate; forming a base with a cavity using a mixture of a polymer and magnetic powder; and attaching the base to the insulative flexible substrate with the coil corresponding in position to the cavity.

To better understand the above-described objectives, characteristics and advantages of the present invention, embodiments, with reference to the drawings, are provided for detailed explanations.

### BRIEF DESCRIPTION OF THE DRAWINGS

The invention will be described according to the appended drawings in which:

FIG. 1 is a schematic view showing an electro-acoustic transducer according to one embodiment of the present invention;

FIG. 2 is a cross-sectional view along line 1-1 of FIG. 1;

FIG. 3 is a schematic view showing coils of an electro-acoustic transducer according to one embodiment of the present invention;

FIG. 4 is a cross sectional view along line 2-2 of FIG. 3;

FIG. 5 is a schematic view showing an insulating layer covering coils according to one embodiment of the present invention;

FIG. 6 is a cross-sectional view along line 3-3 of FIG. 5;

FIG. 7 is a schematic view showing a circuit layer formed on an insulating layer according to one embodiment of the present invention;

FIG. 8 is a cross-sectional view along line 4-4 of FIG. 7;

FIG. 9 is a schematic view showing a base according to one embodiment of the present invention;

FIG. 10 is a cross-sectional view along line 5-5 of FIG. 9; and

FIG. 11 is a schematic view showing an electro-acoustic transducer according to one embodiment of the present invention.

### DETAILED DESCRIPTION OF THE INVENTION

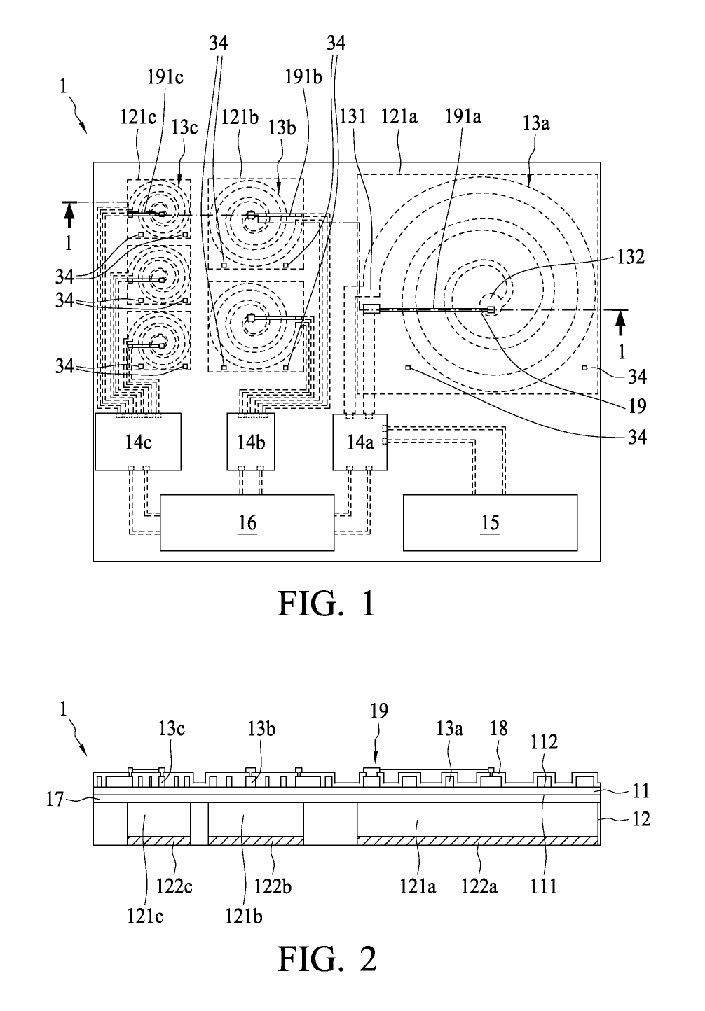

FIG. 1 is a schematic view showing an electro-acoustic transducer 1 according to one embodiment of the present invention. FIG. 2 is a cross-sectional view along line 1-1 of FIG. 1. Referring to FIGS. 1 and 2, the electro-acoustic transducer 1 comprises an insulative flexible substrate 11, a base 12, and at least one magnetic field generator (13a, 13b, or 13c). The base 12 can be formed with at least one cavity (121a, 121b or 121c) and at least one magnetic portion (122a, 122b or 122c), each formed below a corresponding cavity (121a, 121b or 121c), as shown in FIG. 1. The insulative flexible substrate 11 is disposed on the base 12, covering the at least one cavity (121a, 121b or 121c). The insulative flexible substrate 11 can be supported by the base 12 and the cavity (121a, 121b or 121c) provides space to allow the insulative flexible substrate 11 to vibrate. The magnetic field generator (13a, 13b, or 13c) corresponds to the at least one cavity (121a, 121b or 121c) and is formed on the insulative flexible substrate 11. The magnetic field generator (13a, 13b, or 13c) is configured to generate a magnetic field and a reverse magnetic field. The magnetic field or reverse magnetic field can interact with the corresponding magnetic portion (122a, 122b or 122c), thereby generating forces of attraction or repulsion on the magnetic field generator (13a, 13b, or 13c) and moving the insulative flexible substrate 11. As the magnetic field generator (13a, 13b, or 13c) continuously and alternatively generates magnetic fields and reverse magnetic fields, the insulative flexible substrate 11 may vibrate, compress air, and generate sound waves.

In one embodiment, as shown in FIG. 2, the insulative flexible substrate 11 may comprise a first surface 111 and a second surface 112. The base 12 can be attached to the first surface 111 of the insulative flexible substrate 11 using an adhesive 17. In one embodiment, the magnetic portion (122a, 122b or 122c) and the first surface 111 can be oppositely disposed relative to the at least one cavity (121a, 121b or 121c). In one embodiment, the magnetic field generator (13a, 13b, or 13c) can be disposed on the second surface 112.

As shown in FIG. 1, in one embodiment, the electro-acoustic transducer 1 may comprise a plurality of magnetic field generators (13a, 13b, and 13c). The plurality of magnetic field generators (13a, 13b, and 13c) are configured to vibrate corresponding portions of the insulative flexible substrate 11, which have different sizes such that the electro-acoustic transducer 1 can produce sounds of different frequencies. In one embodiment, the electro-acoustic transducer 1 may comprise a magnetic field generator 13a, which is configured to vibrate a large portion of the insulative flexible substrate 11 to generate sounds in a low frequency range. Correspondingly, the at least one cavity 121a under the magnetic field generator 13a has a larger area. In one embodiment, the electro-acoustic transducer 1 may comprise a plurality of magnetic field generators 13b, each configured to vibrate a smaller portion of the insulative flexible substrate 11 to generate sounds in a mid-frequency range. Correspondingly, cavities 121b with smaller areas are disposed under the magnetic field generators 13b. In one embodiment, the electro-acoustic transducer 1 may comprise a plurality of magnetic field generators 13c, each configured to vibrate a further smaller portion of the insulative flexible substrate 11 to generate sounds in a high frequency range. Correspondingly, cavities 121c with the smallest areas are disposed under the magnetic field generators 13c.

The magnetic field generator (13a, 13b, or 13c) can be any device that can produce a magnetic field. In one embodiment, the magnetic field generator (13a, 13b, or 13c) may comprise a planar coil. In one embodiment, the planar coil may comprise an electrically conductive adhesive.

In one embodiment, the base 12 may comprise a polymer, such as plastic. In other words, the base 12 can be formed by injection molding. Moreover, the magnetic portion (122a, 122b or 122c) may comprise a polymer and magnetic powder. The magnetic powder may comprise permanent magnetic ferrite powder. In one embodiment, the base 12 may comprise a polymer and magnetic powder, and the base 12 can be formed by injection molding with a mixture of the polymer and the magnetic powder.

As shown in FIG. 1, in one embodiment, the electro-acoustic transducer 1 may further comprise at least one signal processor (14a, 14b, or 14c). The signal processor (14a, 14b, or 14c) is coupled with a corresponding magnetic field generator (13a, 13b, or 13c) to drive the magnetic field generator (13a, 13b, or 13c) to produce a magnetic field or a reverse magnetic field.

Specifically, when the magnetic field generator 13a is a coil and the signal processor 14a provides a current flowing from an outer end 131 of the magnetic field generator 13a to the inner end 132 of the magnetic field generator 13a, the magnetic field generator 13a produces a magnetic field. Moreover, when the signal processor 14a reverses the direction of the current, flowing from the inner end 132 toward the outer end 131, the magnetic field generator 13a produces a reverse magnetic field.

In one embodiment, when the electro-acoustic transducer 1 comprises a plurality of magnetic field generators (13a, 13b, and 13c) configured to generate sounds in different frequency ranges, the electro-acoustic transducer 1 may comprise a plurality of signal processors (14a, 14b, and 14c) corresponding to the magnetic field generators (13a, 13b, and 13c) for driving the magnetic field generators (13a, 13b, and 13c).

The electro-acoustic transducer 1 may further comprise a battery socket 15, which can be coupled with the at least one signal processor (14a, 14b, or 14c) and configured to be able to connect with a battery for supplying electrical power to the electro-acoustic transducer 1.

The electro-acoustic transducer 1 may further comprise an audio signal connector 16, which can be coupled with the at least one signal processor (14a, 14b, or 14c) and configured to be able to connect with a plug of an audio source such that the audio source can provide audio signals for the signal processor (14a, 14b, or 14c) through the audio signal connector 16, and the signal processor (14a, 14b, or 14c) can generate signals for driving the magnetic field generator (13a, 13b, or 13c) using the audio signals. In one embodiment, the at least one signal processor (14a, 14b, or 14c) comprises an amplifier, which can amplify audio signals for driving the magnetic field generator (13a, 13b, or 13c).

As shown in FIGS. 1 and 2, the electro-acoustic transducer 1 may further comprise an insulating layer 18 and a circuit layer 19. The insulating layer 18 is configured to cover the at least one magnetic field generator (13a, 13b, or 13c). The circuit layer 19 is formed on the insulating layer 18 and comprises at least one circuit (191a, 191b, or 191c). A plurality of openings can be formed on the insulating layer 18 to expose the inner end 132 of the at least one magnetic field generator (13a, 13b, or 13c) and an end of a conductive line for connecting with the at least one signal processor (14a, 14b, or 14c). The at least one circuit (191a, 191b, or 191c) is configured to connect the inner end 132 and the end of the conductive line.

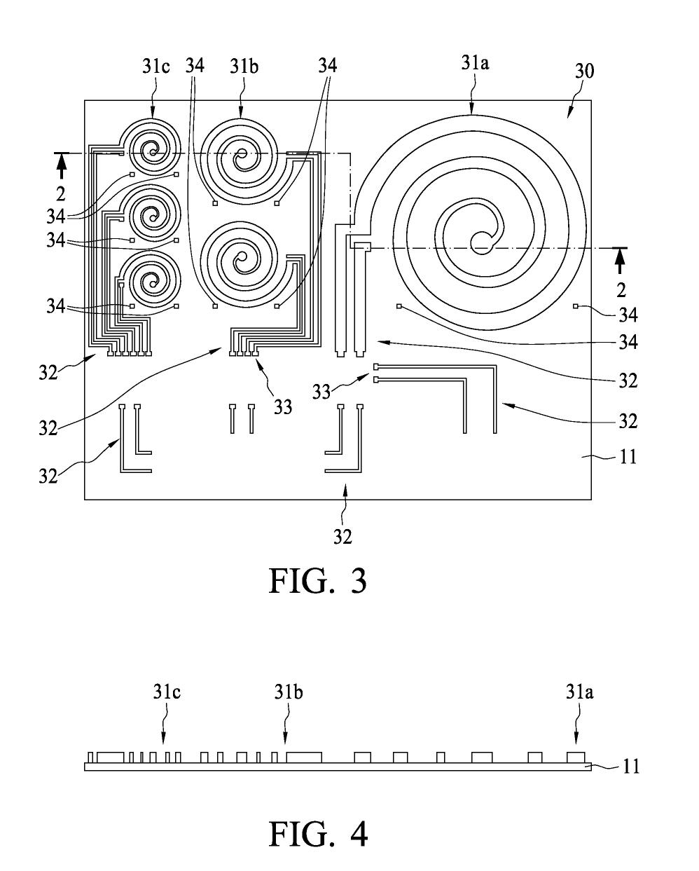

One embodiment of the present invention discloses a method of manufacturing an electro-acoustic transducer. Referring to FIGS. 3 and 4 (showing cross sections along line 2-2 of FIG. 3), the method initially forms a circuit layer 30 on an insulative flexible substrate 11, wherein the circuit layer 30 comprises at least one coil (31a, 31b, or 31c), and a plurality of conductive lines 32 and conductive pads 33. A portion of conductive lines 32 are connected with the outer end of the at least one coil (31a, 31b, or 31c) and corresponding conductive pads 33. One group of ends of a portion of conductive lines 32 are connected with the corresponding conductive pads 33, while another group of ends of the portion of the conductive lines 32 extend adjacent to the at least one coil (31a, 31b, or 31c). The insulative flexible substrate 11 may comprise a polymer, such as plastic. The circuit layer 30 can be formed on the insulative flexible substrate 11 using a screen-printing technology. The circuit layer 30 can be a conductive adhesive pattern with a thickness range of 20 to 100 micrometers and made by silver paste.

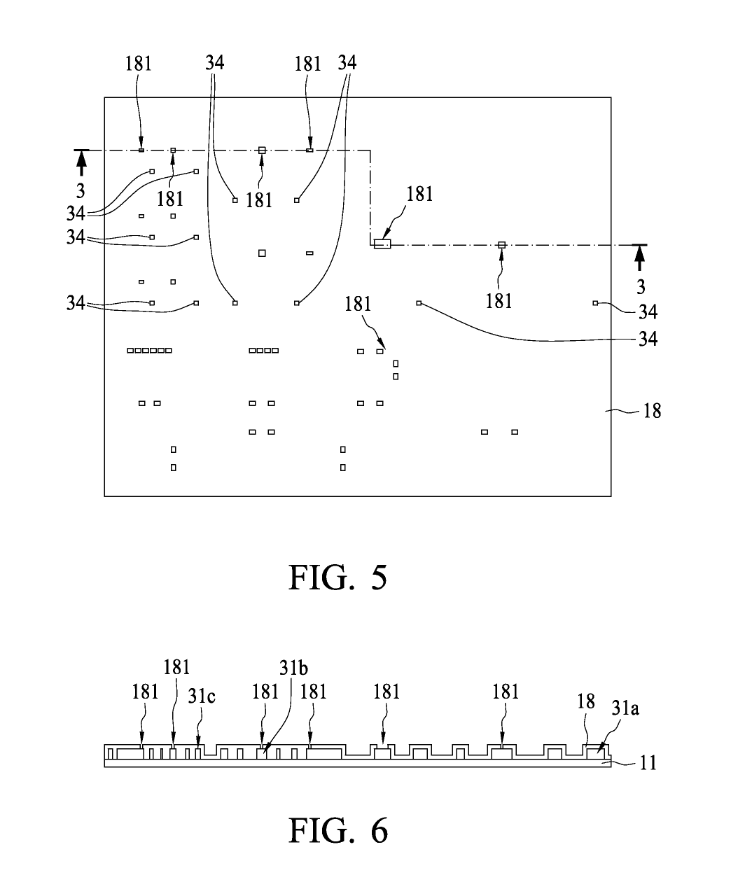

Referring to FIGS. 5 and 6 (showing cross sections along line 3-3 of FIG. 5), an insulating layer 18 is formed to cover the circuit layer 30. In one embodiment, the insulating layer 18 may comprise a photoresist. In one embodiment, the insulating layer 18 may comprise polyvinylamine In one embodiment, the insulating layer 18 can have a thickness range of 1 to 10 micrometers. A plurality of openings 181 are formed on the insulating layer 18. The openings 181 can expose a portion of the inner end of the at least one coil (31a, 31b, or 31c) and the ends of the conductive lines 32 adjacent to the at least one coil (31a, 31b, or 31c).

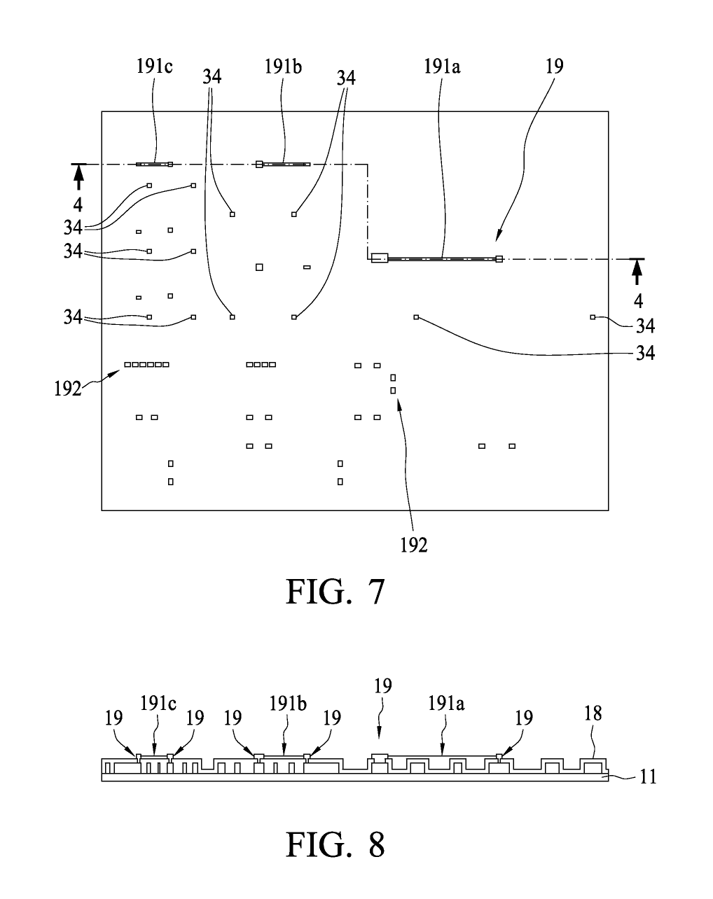

Referring to FIGS. 7 and 8 (showing cross sections along line 4-4 of FIG. 7), a circuit layer 19 is formed on the insulating layer 18. The circuit layer 19 may comprise at least one conductive line (191a, 191b, or 191c). The at least one conductive line (191a, 191b, or 191c) connects the inner end of the at least one coil (31a, 31b, or 31c) and an end of the conductive line 32 adjacent to the at least one coil (31a, 31b, or 31c). The circuit layer 19 can have a thickness range of 20 to 100 micrometers. The circuit layer 19 can further comprise a plurality of conductive pads 192, which are electrically connected with the corresponding conductive pads 33 of the circuit layer 30.

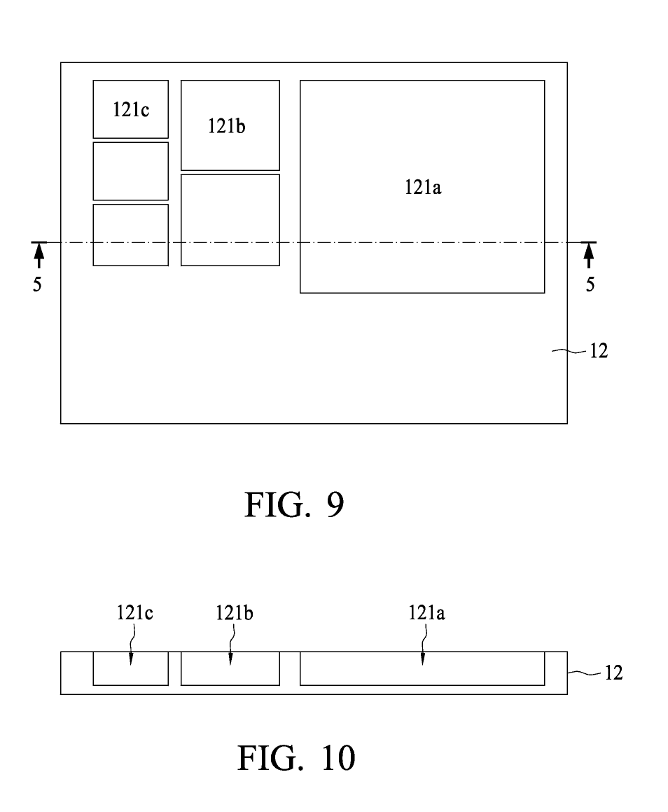

Referring to FIGS. 9 and 10 (showing cross sections along line 5-5 of FIG. 9), a mixture is obtained by mixing a polymer and magnetic powder. The mixture is used to form a base 12, which comprises at least one cavity (121a, 121b or 121c). Next, the base 12 is attached to the insulative flexible substrate 11, which covers the at least one cavity (121a, 121b or 121c). The at least one coil (31a, 31b, or 31c) corresponds in position to the at least one cavity (121a, 121b or 121c).

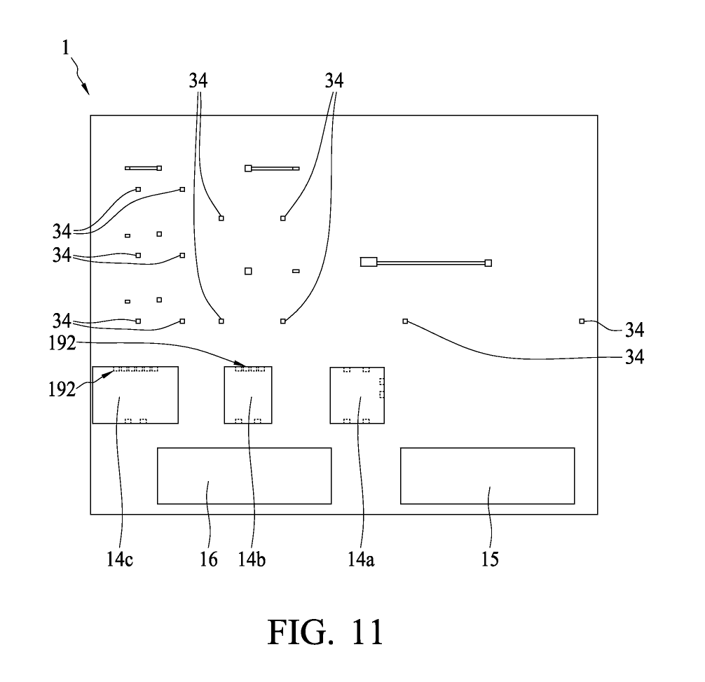

Referring to FIG. 11, at least one signal processor (14a, 14b, or 14c) is disposed and electrically connected with the plurality of corresponding pads 192. An audio signal connector 16 is disposed on the insulative flexible substrate 11. The audio signal connector 16 is electrically connected with the corresponding pads 192 and the conductive lines 32 extending to connect with the at least one signal processor (14a, 14b, or 14c), as shown in FIG. 3. A battery socket 15 is disposed on the insulative flexible substrate 11. The battery socket 15 is electrically connected with the corresponding pads 192 and another set of conductive lines 32 extending to connect with the at least one signal processor (14a, 14b, or 14c).

In one embodiment, a plurality of openings 34 can be formed on the insulative flexible substrate 11 in advance. The plurality of openings 34 allow air to flow into or out of the cavity (121a, 121b or 121c) when the insulative flexible substrate 11 is vibrating. The size and depth of the cavity (121a, 121b or 121c) can be changed to generate a desired resonant effect to make sounds in a frequency range produced by the integration of the cavity (121a, 121b or 121c) and the insulative flexible substrate 11.

In one embodiment, the size, shape, and thickness of the coil and the thickness and material of the insulative flexible substrate 11 can be changed to generate a desired resonant effect to sounds in a frequency range produced by the integration of the cavity (121a, 121b or 121c) and the insulative flexible substrate 11.

The above-described embodiments of the present invention are intended to be illustrative only. Numerous alternative embodiments may be devised by persons skilled in the art without departing from the scope of the following claims.

What is claimed is:

1. An electro-acoustic transducer comprising:
an insulative flexible substrate;
a base comprising a cavity covered by the insulative flexible substrate and a magnetic portion disposed below the cavity; and
a magnetic field generator disposed on the insulative flexible substrate and corresponding to the cavity;
wherein the magnetic field generator is configured to produce a magnetic field and a reverse magnetic field to cause the magnetic field generator and the magnetic portion of the base to attract and repel each other, thereby vibrating the insulative flexible substrate.

2. The electro-acoustic transducer of claim 1, wherein the magnetic field generator comprises a planar coil.

3. The electro-acoustic transducer of claim 2, wherein the magnetic field generator comprises a conductive adhesive.

4. The electro-acoustic transducer of claim 1, wherein the magnetic portion comprises a polymer and magnetic powder.

5. The electro-acoustic transducer of claim 1, wherein the base comprises a polymer and magnetic powder.

6. The electro-acoustic transducer of claim 1, further comprising a signal processor coupled with the magnetic field generator, wherein the signal processor is configured to drive the magnetic field generator to produce the magnetic field and the reverse magnetic field.

7. The electro-acoustic transducer of claim 6, further comprising a battery socket coupled with the signal processor.

8. The electro-acoustic transducer of claim 6, further comprising an audio signal connector coupled with the signal processor.

9. An electro-acoustic transducer comprising:
an insulative flexible substrate comprising a first surface and a second surface;
a base comprising a cavity and a magnetic portion, wherein the base is attached to the first surface, the insulative flexible substrate covers the cavity, and the magnetic portion and the first surface are oppositely disposed relative to the cavity;
a coil disposed on the second surface and corresponding to the cavity, wherein the coil is configured to generate a magnetic field and a reverse magnetic field to cause the coil and the magnetic portion of the base to attract and repel each other, thereby vibrating the insulative flexible substrate;
a signal processor coupled with the coil, the signal processor configured to filter and amplify an audio signal and to drive the coil to generate the magnetic field and the reverse magnetic field; and
an audio signal connector coupled with the signal processor, configured to provide the coil with a signal that causes the coil to generate the magnetic field or the reverse magnetic field.

10. The electro-acoustic transducer of claim 9, wherein the coil comprises a conductive adhesive.

11. The electro-acoustic transducer of claim 9, wherein the magnetic portion comprises materials of polymer and magnetic powder.

12. The electro-acoustic transducer of claim 9, wherein the base comprises materials of polymer and magnetic powder.

13. The electro-acoustic transducer of claim 9, further comprising a battery socket coupled with the signal processor.

14. The electro-acoustic transducer of claim 9, further comprising an insulting layer covering the coil and a circuit formed on the insulating layer, wherein the circuit is coupled with the an audio signal connector and an inner end of the coil.

15. A method of manufacturing an electro-acoustic transducer, comprising the steps of:
forming a coil on an insulative flexible substrate;
forming a base with a cavity using a mixing materials of polymer and magnetic powder; and
attaching the base to the insulative flexible substrate with the coil corresponding in position to the cavity.

16. The method of claim 15, further comprising the steps of:
covering the coil with an insulating layer; and
forming a circuit coupled with an inner end of the coil on the insulating layer.

17. The method of claim 15, further comprising a step of disposing a signal processor coupled with the coil on the insulative flexible substrate.

18. The method of claim 17, further comprising a step of disposing a battery socket coupled with the signal processor on the insulative flexible substrate.

19. The method of claim 17, further comprising a step of disposing an audio signal connector coupled with the signal processor on the insulative flexible substrate.

20. The method of claim 15, further comprising a step of forming a plurality of openings on the insulative flexible substrate.
